(19) United States
(12) Patent Application Publication
(10) Pub. No.: US 2026/0265845 A1
(43) Pub. Date: Sep. 10, 2026

(54) A method for manufacturing molten pig iron into an electrical smelting furnace

(71) Applicant: ArcelorMittal, Luxembourg (LU)

(72) Inventors: Jean-Christophe HUBER, Vry (FR); Mathieu SANCHEZ, Plappeville (FR); Eric Alain Gabriel HESS, Metz (FR)

(21) Appl. No.: 18/881,434

(22) PCT Filed: Jul. 29, 2022
(86) PCT No.: PCT/IB2022/057034

§ 371 Date: Jan. 6, 2025

(51) Int. Cl. C21B 11/10; C21C 7/00; C21C 7/064

(52) U.S. Cl. CPC C21B 11/10; C21C 7/0025; C21C 7/064

(57) ABSTRACT

A method for manufacturing molten pig iron into an electrical smelting furnace 13, the method including the following successive steps: providing a directly reduced iron product, providing a carbon containing material, feeding at least a part of the smelting furnace with the DRI product in alternance with the carbon containing material, melting the DRI Product and the carbon containing material to produce molten pig iron. It also deals with the manufacturing of steel from the pig iron.

The present invention is related to a method of manufacturing pig iron, also called hot metal and to a method of producing steel out of such pig iron.

### BACKGROUND

Currently, steel can be produced through two mains manufacturing routes. Nowadays, the most commonly used production route named “BF-BOF route” consists of producing hot metal in a blast furnace, by use of a reducing agent, mainly coke, to reduce iron oxides and then transform hot metal into steel in a converter process or Basic Oxygen furnace (BOF). This route, both in the production of coke from coal in a coking plant and in the production of the hot metal, releases significant quantities of CO₂.

The second main route involves so-called “direct reduction methods”. Among them are methods according to the brands MIDREX®, FINMET®, ENERGIRON®/HYL, COREX®, FINEX® etc., in which sponge iron is produced in the form of HDRI (hot direct reduced iron), CDRI (cold direct reduced iron), or HBI (hot briquetted iron) from the direct reduction of iron oxide carriers. Sponge iron in the form of HDRI, CDRI, and HBI undergoes further processing in electric furnaces to produce steel.

### SUMMARY OF THE INVENTION

One of the main options chosen by steelmakers to reduce CO₂ emissions is therefore to switch from the BF-BOF route towards the DRI route. However, use of DRI products in classical electrical furnaces together with ferrous scraps has some limitations. Indeed, scraps contain a lot of impurities and resulting liquid steel will need to be further processed to produce high quality steel grades. Investment on new liquid steel treatment tools would thus be necessary.

Another option consists in using smelting furnaces powered by electric energy to melt the DRI products to produce pig iron. This option has the advantage that pig iron is produced, as in the Blast Furnace, which allows oxides removal in molten slag and thus classical liquid steel treatment tools such a Basic Oxygen Furnace and refining ladles may be used. However, the pig iron obtained by this route has a carbon content which is relatively low compared to classical pig iron. This paradoxically reduces the environmental interest of this route because the higher the carbon rate, the more it will be possible to add recycled scrap metal in the BOF.

An aim of the present invention is to remedy the drawbacks of the pig iron and steelmaking manufacturing routes by providing a new route efficiently minimizing the environmental impact of such manufacturing.

The present invention provides a method for manufacturing molten pig iron into an electrical smelting furnace, comprising the steps of:
i) providing a directly reduced iron product,
ii) providing a carbon containing material,
iii) feeding at least a part of the smelting furnace with the DRI product in alternance with the carbon containing material,
iv) melting the DRI Product and the carbon containing material to produce molten pig iron.

### BRIEF DESCRIPTION OF THE DRAWINGS

Other characteristics and advantages of the present invention will emerge clearly from the description of it that is given below by way of an indication and which is in no way restrictive, with reference to the appended figures in which:

FIG. 1 illustrates schematically a pig iron and steelmaking process according to the smelting/BOF route,

FIG. 2 illustrates schematically a smelting furnace, and

FIG. 3 illustrates schematically raw material charging according to an embodiment of the present invention.

Elements in the figures are illustrations and may not have been drawn to scale.

### DETAILED DESCRIPTION

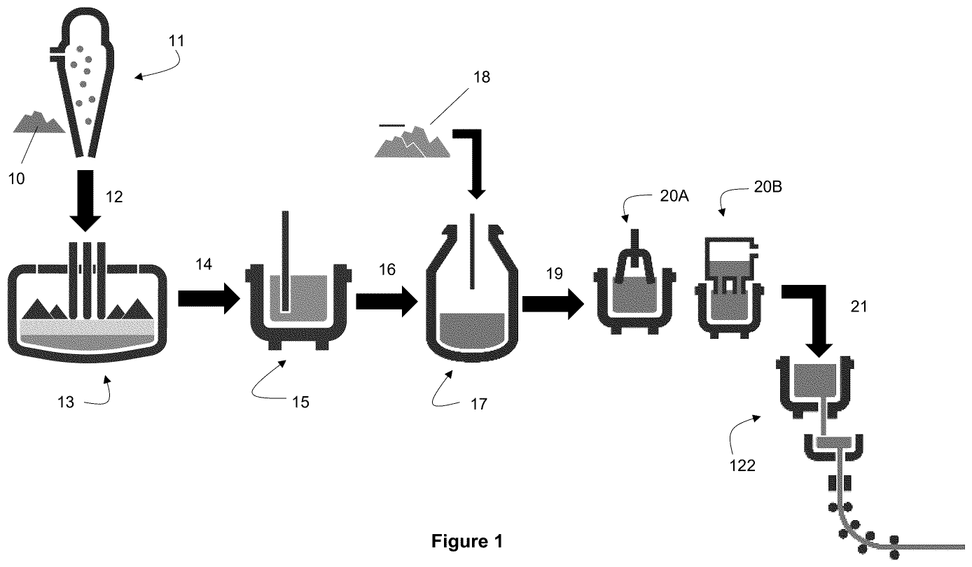

FIG. 1 schematically illustrates a steel production route according to the DRI route, from the reduction of iron to the casting of the steel into semi-products such as slabs, billets, blooms, or strips.

Iron ore 10 is first reduced in a direct reduction plant 11. This direct reduction plant 11 may be designed to implement any kind of direct reduction technology such as MIDREX® technology or Energiron®. The direct reduction process may for example be a traditional natural-gas or a biogas-based process.

In a preferred embodiment, the DRI product used in the method according to the present invention is manufactured using a reducing gas based on biogas coming from combustion of biomass.

Biomass is renewable organic material that comes from plants and animals. Biomass sources include notably wood and wood processing wastes such as firewood, wood pellets, and wood chips, lumber and furniture mill sawdust and waste, and black liquor from pulp and paper mills, agricultural crops and waste materials such as corn, soybeans, sugar cane, switchgrass, woody plants, and algae, and crop and food processing residues, but also biogenic materials in municipal solid waste such as paper, cotton, and wool products, and food, yard, and wood wastes, animal manure and human sewage. In the sense of the present invention, biomass may also encompass plastics residues, such as recycled waste plastics like Solid Refuse Fuels or SRF.

Whenever using natural gas or biogas as reducing gas, the carbon content of the DRI product can be set to a maximum of 3% in weight and usually to a range of 2 to 3% in weight.

In another preferred embodiment, the DRI product used in the method according to the present invention is manufactured through a so called H₂-DRI process where the reducing gas comprises more than 50% and preferably more than 60, 70, 80 or 90% in volume of hydrogen or is even entirely made of hydrogen. The H₂-DRI product will contain a far lower level of carbon than the natural gas or biogas DRI, so typically below 1% in weight or even lower.

In a preferred embodiment, the hydrogen used in the DRI reducing gas comes from the electrolysis of water, which is preferably powered in part or all by CO₂ neutral electricity. CO₂ neutral electricity includes notably electricity from renewable source which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO₂ to be produced.

Whatever the DRI process used, the resulting Direct Reduced Iron (DRI) Product 12 is then charged into a smelting furnace 13 where the reduction of iron oxide is completed, and the product is melted to produce pig iron.

The DRI product can be transferred to the smelting furnace in various forms. Preferably, the directly reduced iron product (DRI product) is fed to the smelting furnace in a hot form as HDRI product (so-called Hot DRI), or in a cold form as CDRI product (so-called Cold DRI), or in hot briquette form as HBI product (so-called Hot Briquetted Iron) and/or in particulate form, preferably with an average particle diameter of at most 10.0 mm, more preferably with an average particle diameter of at most 5.0 mm.

It is preferably charged directly at the exit of the direct reduction plant 11 as a hot product with a temperature from 500° C. to 700° C. This allows reducing the amount of energy needed to melt it. When hot charging is not possible, for example if the direct reduction plant 11 and the smelting furnace 13 are not on same location, or if the smelting furnace 13 is stopped for maintenance and thus DRI product must be stored, then the DRI product may be charged cold, or a preheating step may be performed.

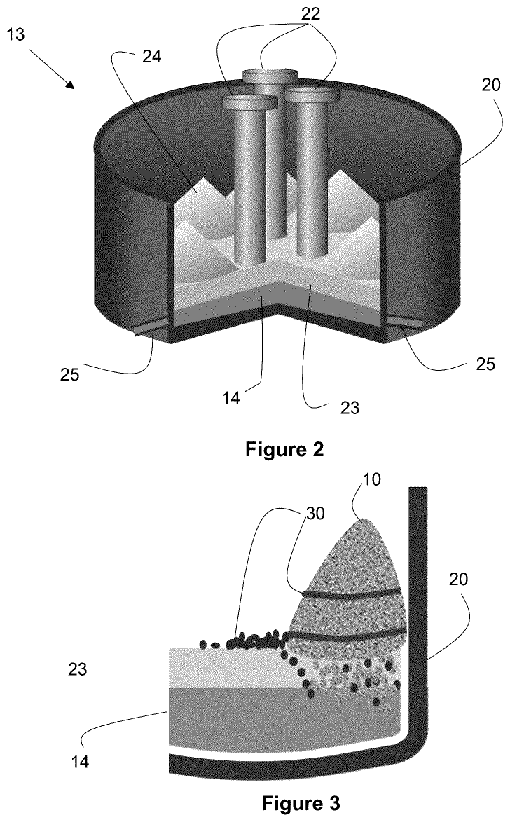

The smelting furnace 13 uses electric energy provided by several electrodes to melt the DRI product 12 and produce a pig iron 14. In a preferred embodiment, part or all of the electricity needed comes from CO₂ neutral electricity. Further detailed description of the smelting furnace will be given later, based on FIG. 2.

The pig iron 14 can be optionally sent to a desulphurization station 15 to perform a desulphurization step. This desulphurization step may be performed in a dedicated vessel or preferentially directly in the pig iron ladle to avoid molten metal transfer and associated heat losses. This desulphurization step is needed for production of steel grades requiring a low Sulphur content, which is, for example set at a maximum of 0.03 weight percent of Sulphur. Desulfurization in oxidizing conditions is not effective and is thus preferentially performed either on pig iron before oxygen refining, or in steel ladle after steel deoxidizing. For very low sulfur contents, for example below 0.004 weight percent of sulfur, deoxidizing and desulphurization are combined for overall higher performance. Low sulfur grades thus benefit from performing pig iron desulfurization before the conversion step.

Desulphurization of the pig iron can be done by adding reagents, notably based on calcium or magnesium compounds, such as sodium carbonate, lime, calcium carbide, and/or magnesium into the pig iron. It may be done for example by injection of those reagents in the pig iron ladle. The desulphurized pig iron 16 has preferably a content of Sulphur lower than 0.03% in weight and preferably lower than 0.004% in weight.

The desulphurized pig iron 16 can then be transferred into a converter 17. The converter basically turns the molten metal into liquid steel by blowing oxygen through molten metal to decarburize it. It is commonly named Basic Oxygen Furnace (BOF). Ferrous scraps 18, coming from recycling of steel, may also be charged into the converter 17 to take benefit of the heat released by the exothermic reactions resulting from the oxygen injection into pig iron.

Liquid steel 19 thus formed can then be transferred, whenever needed, to one or more secondary metallurgy tools 20A, 20B such as Ladle furnaces, RH (Ruhrstahl-Heareus) vacuum vessel, Vacuum Tank degasser, alloying and stirring stations, etc. . . . to be treated to reach the required steel composition according to the steel grades to be produced. Liquid steel with the required composition 21 can then be transferred to a casting plant 122 where it can be turned into solid products, such as slabs, billets, blooms, or strips.

As schematically shown on FIG. 2, the smelting furnace 13 is composed of a vessel 20 able to contain hot metal. The vessel 20 may have a circular or a rectangular shape, for example. This vessel 20 is closed by a roof provided with some apertures to receive electrodes 22 to be inserted into the vessel 20 and with other apertures to allow charging of the raw materials into the vessel 20.

The vessel 20 is also provided with at least one tap hole 25 to allow tapping of manufactured pig iron. Such tap holes 25 are located in the lower part of the vessel 20. They may be located in the lateral walls of the vessel or in its bottom wall.

The electrodes 22 provide the required electric energy to melt the charged raw materials and form pig iron. They are preferably Söderberg-type electrodes. During the melting of the raw materials, two layers are formed, a pig iron 14 layer which is the densest and is thus located at the bottom of the vessel 20 and a slag layer 23 located above the pig iron 14. The slag layer 23 can be partially covered by piles of raw materials 24 waiting to be melted.

The smelting furnace 13 may be a SAF (Submerged-Arc Furnace) wherein the electrodes are immersed into the slag layer 23 or an OSBF (open-slag bath furnace) wherein the electrodes 22 are located above the slag layer 23. It is preferentially an OSBF as illustrated schematically in the figures.

As explained above, the carbon content of the pig iron 14 produced through the DRI route will generally be lower than 3% in weight. However, to fulfil the requirements of the subsequent steelmaking process at the converter, the pig iron should preferentially have a carbon content as close as possible to 4.5% in weight, which is the level of saturation. In a preferred embodiment, the pig iron carbon content is in the range of 4.0 to 4.5% in weight.

Indeed, carbon is necessary for the steelmaking process performed in the converter 17 through oxygen blowing. This is because the reaction of carbon with oxygen creates carbon monoxide gas, which provides intense and efficient stirring of the molten metal and thus improves the removal of impurities from the steel. This reaction is exothermic and therefore provides additional energy for ferrous scraps melting, allowing to incorporate a higher amount of such ferrous scraps coming from steel recycling. The more ferrous scraps used, the smaller the environmental footprint of the steelmaking process.

In the frame of the present invention, during the charging of the vessel 20, the DRI Product 12 is alternatively charged with a carbon containing material 30.

A result of this alternate feeding is schematically illustrated in FIG. 3. The raw materials piles 24 are constituted of alternate layers of carbon containing material 30 and of DRI product 12. This is only a schematic illustration as it is clear for the person skilled in the art that piles of raw materials are not so clean and the boundaries between the different layers are fuzzier. During melting FeC droplets will be formed and transported by the natural slag 23 circulation towards the layer of pig iron 14.

As a matter of example, the smelting furnace 13 is provided with charging means comprising at least two hoppers connected to at least one aperture designed into the roof R of the vessel 20. At least one hopper contains the DRI product 12 and the at least other one contains the carbon containing material 30. When the level of molten metal is low, the first hopper is open to charge DRI into the vessel 20, the second hopper remaining closed. Then the first hopper is closed and the second one is opened to add required quantity of carbon-containing material to reach the required carbon content in the pig iron, which is as previously explained as close as possible to 4.5% in weight.

This method of addition of carbon allows to have an overall density of the raw materials close to a 100% DRI burden and so the presence of the carbon containing material would not impair the downward movement of the burden during melting.

Carbon is then transported through the slag layer and into liquid metal by gravity feed in the DRI piles. The slag layer 23 has a high thickness that can be above 50 cm and the density of carbon sources is usually lower than the slag density itself. This triggers physical limitations for carbon to go through the slag into the pig iron layer 14. With the method according to the present invention it is possible to overcome this limitation.

Moreover, the addition of carbon at the smelting stage ensures optimal energy efficiency of the steelmaking process as carburization requires a high amount of energy that can be optimally provided by electric heating in the smelting furnace rather than by an additional heating station.

The carbon containing material may come from different sources. It may be chosen, for example, among coke, anthracite, silicon carbide, calcium carbide, or a mixture of any of those sources, but can also advantageously come from renewable sources like biomass for part or all the carbon loads. In particular, biochar can be used. Adding calcium carbide is particularly advantageous as the calcium atoms can provide a desulphurizing effect.

The carbon containing material to be added preferably has the same size as the DRI product to use same feeding equipment.

As a matter of illustration, for a DRI product coming from a Natural gas reduction process, 30 kg of anthracite per ton of pig iron produced are added.

In a preferred embodiment, desulphurization reagents can also be fed together with the carbon containing material. Such reagents can notably be based on calcium compounds, such as sodium carbonate, lime, and/or calcium carbide.

The final sulphur content of the pig iron is preferentially set at a maximum value of 0.03 weight percent and preferably at a maximum value of 0.004 weight percent.

Performing desulphurization in the smelting furnace can allow suppressing the need for a desulphurization treatment between the smelting furnace 13 and the converter 17 or at least reducing such treatment.

In a preferred embodiment, silicon containing material may be charged together with the carbon containing material, with or without desulfurization reagents. Silicon has a strong deoxidizing power at high temperature and notably around 1600° C. which is the temperature of the liquid steel in the converter. It reacts with oxygen and contributes then to the formation of the slag in the converter. The reaction is exothermic and therefore provides additional energy for scrap melting. The more scrap is used, the smaller the environmental footprint of the process.

Such silicon can be added under different forms. It may be metal Silicon Si, silicon carbide SiC, silicomanganese SiMn, calcium silicate SiCa or a ferro silicon alloy FeSi such as FeSi75 or FeSi65.

The use of DRI products in the smelting furnace 13 will lead to a natural amount of silicon usually below 0.2 or even below 0.1% in weight. The final silicon content of the pig iron is preferentially set at a value of 0.1 to 0.4% in weight, preferably of 0.2 to 0.4% in weight. Further additions of silicon in the converter 17 may be performed if required.

Adding silicon carbide is particularly advantageous as it allows increasing the silicon content of the pig iron on top of adding carbon. Adding a mix of calcium carbide and silicon carbide is even more advantageous as it provides carbon and silicon addition, while ensuring desulphurization.

What is claimed is:

1-10. (canceled)

11. A method for manufacturing molten pig iron into an electrical smelting furnace, the method comprising the following successive steps of:
providing a directly reduced iron product;
providing a carbon containing material;
feeding at least a part of the smelting furnace with the DRI product in alternance with the carbon containing material; and
melting the DRI product and the carbon containing material to produce the molten pig iron.

12. The method according to claim 11 wherein the carbon containing material is added in an amount sufficient to reach a final carbon content of 4.0 to 4.5% in weight in the molten pig iron.

13. The method according to claim 11 wherein the carbon containing material is chosen from at least one of the group consisting of: coke, anthracite, silicon carbide, calcium carbide, biomass, carbon resulting from combustion of biomass and a mixture of any of those materials.

14. The method according to claim 11 wherein the DRI product is provided at a temperature from 500 to 700° C.

15. The method according to claim 11 wherein, before being loaded in the smelting furnace, the DRI product is manufactured using a reducing gas containing at least 50% in volume of hydrogen.

16. The method according to claim 11 wherein a silicon containing material is added to the carbon containing material.

17. The method according to claim 11 wherein the carbon containing material and the DRI product are provided as briquettes having a same size.

18. A method for manufacturing steel employing the method as recited in claim 11, comprising the steps of:
transferring the pig iron from the smelting furnace to a converter; and
lowering a carbon content of the pig iron to a value below 2.1 percent in weight by blowing oxygen to obtain liquid steel.

19. The method for manufacturing steel according to claim 18 wherein ferrous scraps are added to the pig iron in the converter, the ferrous scraps being melted.

20. The method for manufacturing steel according to claim 18 wherein the pig iron is transferred from the smelting furnace to a desulphurization station before being transferred to the converter.
